(19) United States
(12) Patent Application Publication
(10) Pub. No.: US 2016/0371629 A1
(43) Pub. Date: Dec. 22, 2016

(54) METHOD FOR COST EFFICIENT FULFILLMENT

(71) Applicant: Target Brands, Inc., Minneapolis, MN (US)

(72) Inventors: Alind Agrawal, Bangalore (IN); Amit Pradhan, Bangalore (IN); Rahul Chokhani, Bangalore (IN)

(21) Appl. No.: 14/742,103

(22) Filed: Jun. 17, 2015

(51) Int. Cl. G06Q 10/08; G06Q 30/06

(52) U.S. Cl. CPC G06Q 10/087; G06Q 30/0635; G06Q 10/083

(57) ABSTRACT

A computer-implemented method includes receiving a list of items in a purchase order and accessing inventories of items available at each location. The functioning of the computer is improved by reducing the number of combinations of locations and items that must be considered to find a combination of locations and items that provides a lowest total fulfillment cost through steps that begin with identifying all combinations of the items in the list of items. For each combination, a location that can ship that combination at a lowest fulfillment cost is identified. A fulfillment superset is selected that is formed from one or more combinations, provides all of the items in the list of items and has a lowest total fulfillment cost.

### BACKGROUND

There are two basic methods for purchasing items. In the first method, the purchaser goes to a store, selects the item they want, purchases the item and takes the item back with them. In the second method, the purchaser submits an order for the item, the vendor packages the item and ships it to the purchaser. Often, many items may be listed in an order. Packaging and shipping all the items in an order is referred to as fulfillment of the order. Packaging of the items is often referred to as handling and can include selecting the items from shelves or other containers, placing the items in boxes or other shipping structures and placing a shipping label on the shipping structure(s) that will allow a carrier to deliver the shipping structure(s) to the proper destination.

The discussion above is merely provided for general background information and is not intended to be used as an aid in determining the scope of the claimed subject matter. The claimed subject matter is not limited to implementations that solve any or all disadvantages noted in the background.

### SUMMARY

A computer-implemented method includes receiving a list of items in a purchase order and for each of a plurality of locations, accessing inventories of items available at the location. The functioning of the computer is improved by reducing the number of combinations of locations and items that must be considered to find a combination of locations and items that provides a lowest total fulfillment cost through steps that begin with identifying all combinations of the items in the list of items. For each combination, a location that can ship that combination at a lowest fulfillment cost is identified. A fulfillment superset is selected that is formed from one or more combinations, provides all of the items in the list of items and has a lowest total fulfillment cost.

In a further embodiment, a method of shipping retail items is provided that includes receiving a list of items to be shipped to a same destination and for each subset of one or more items in the list of items, identifying whether there is one shipping location from a plurality of shipping locations that can ship the subset of items at a lowest cost. A superset of locations is formed, where each location in the superset can ship at least one subset of items at a lowest cost, and wherein the superset of locations provides a lowest cost to package and ship all of the items of the list of items to the same destination. The items are then shipped from the locations in the superset to the same destination.

In a further embodiment, a server includes a memory, storing product inventories for a plurality of locations, and a network interface, receiving a list of items to be shipped to a destination. A processor in the server determines which locations will ship which items in the list of items through a process that includes identifying all possible subsets of items in the list of items; identifying a lowest cost location for each subset of items; and combining lowest cost locations to form a superset of locations such that, together, the locations of the superset of locations will ship all of the items in the list of items.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 provides a flow diagram of a method of identifying a set of locations from which to ship items in an order.

FIG. 2 provides a block diagram of an environment used in the flow diagram of FIG. 1.

FIGS. 3A and 3B together provide a flow diagram for generating a list of shipments.

FIG. 4 provides an example of a list of shipments/subsets.

FIG. 5 provides a flow diagram of a method of determining a least cost and a least cost shipping location for each subset/shipment in a shipment list.

FIG. 6 provides a flow diagram for creating a shipment-location map.

FIG. 7 provides a flow diagram for determining a least cost and least cost location for a single shipment.

FIGS. 8A and 8B provide a flow diagram for generating a list of fulfillment options and selecting a least cost fulfillment option.

FIG. 9 provides an example of the construction of supersets.

FIG. 10 provides a flow diagram for finding a subset in the shipment list that has all items of a selected subset and a new item.

FIG. 11 provides an example of a list of supersets.

FIG. 12 provides a block diagram of a general computing device that may be used in various embodiments.

### DETAILED DESCRIPTION

When it is possible to distribute products from several different shipping locations, finding the lowest cost combination of shipping locations can cause a computing device to operate slowly since it must consider each of a large number of possible combinations. For example, if 100 locations each contain all three items in an order, then the computing device must consider over 1 million combinations (100×100×100) for shipping the three items to a same destination. For large-scale systems that are processing thousands of orders per day, considering a million or more options for each order causes the computing device to operate far too slowly to be effective.

Embodiments described below provide methods and machines for improving the functionality of computing devices when determining what location should be used to ship items in order to fulfill a purchase order. In the embodiments, all possible subsets of the items in the order are first identified. For each subset, a location that can provide all the items of the subset at a lowest cost is identified. Supersets of the lowest cost locations are then formed with each superset providing all of the items in the order. The cost of each superset is the sum of the costs provided the lowest cost locations in the superset. The superset with the total lowest cost for all of the items is then selected and the locations in the selected superset are instructed to ship the items to the shipping address. Thus, multiple different locations each ship part of the order to the shipping address. This technique greatly reduces the number of combinations of locations that have to be considered while ensuring that the lowest cost combination of locations is found.

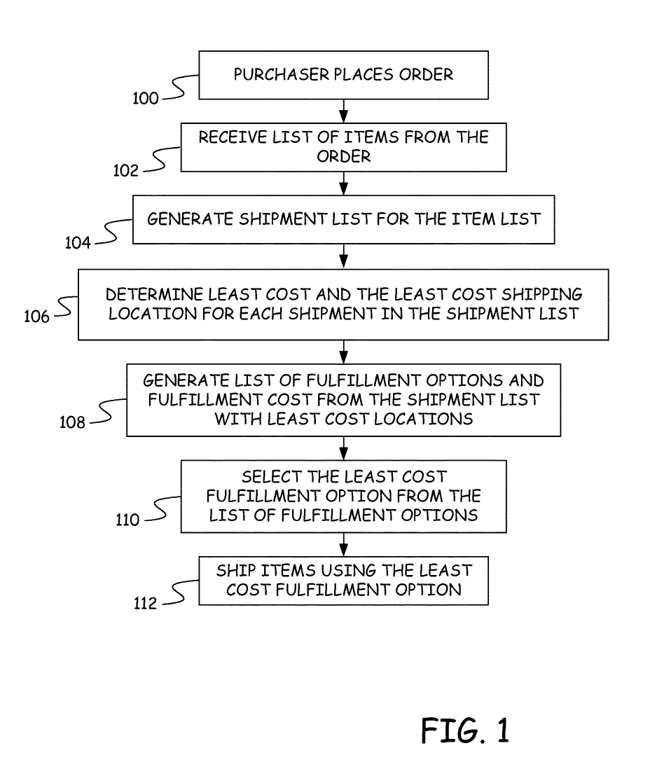

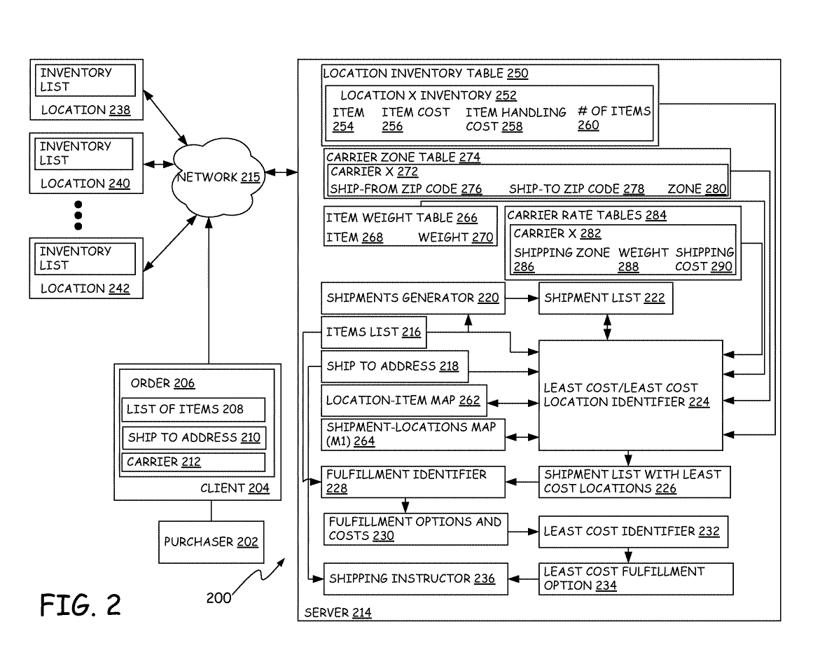

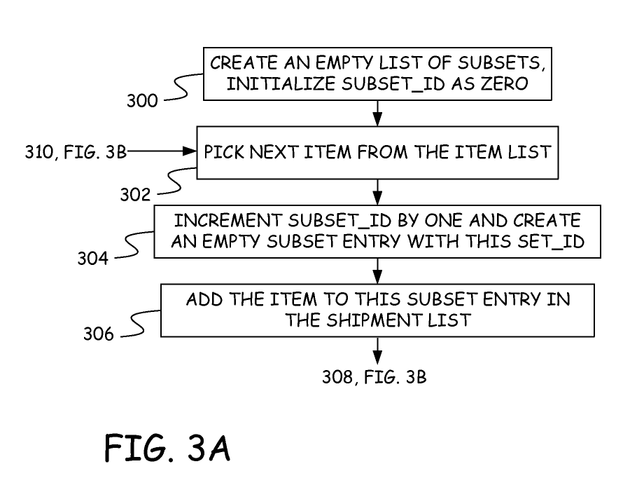

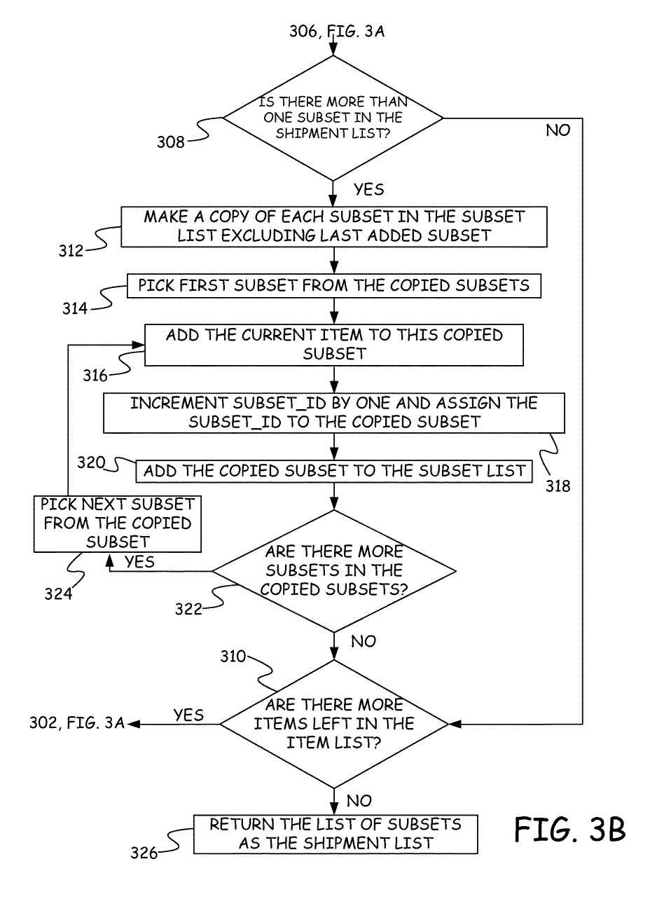

FIG. 1 provides a flow diagram of a method of fulfilling an order while FIG. 2 provides a block diagram of an environment 200 used to perform the method of FIG. 1. At step 100 of FIG. 1, a purchaser 202 uses a client device 204 to submit an order 206 containing a list of items 208, a ship-to address 210 and a carrier identifier 212. Client device 204 transmits order 206 through network 215 to a server 214, which receives the order at step 102 and stores the list of items 208 as items list 216 and ship-to address 210 as ship-to address 218. In order 206, all of the items of items list 216 are to be shipped to a same destination indicated by ship-to address 210. At step 104, a shipment generator 220 in server 214 generates a shipment list 222 from items list 216. Shipment list 222 is a list of shipments where each shipment is a subset of the items in item list 216 and the list of shipments together provide every subset that can be formed from the items in item list 216. The generation of shipment list 222 is discussed further below in connection with FIGS. 3A and 3B.

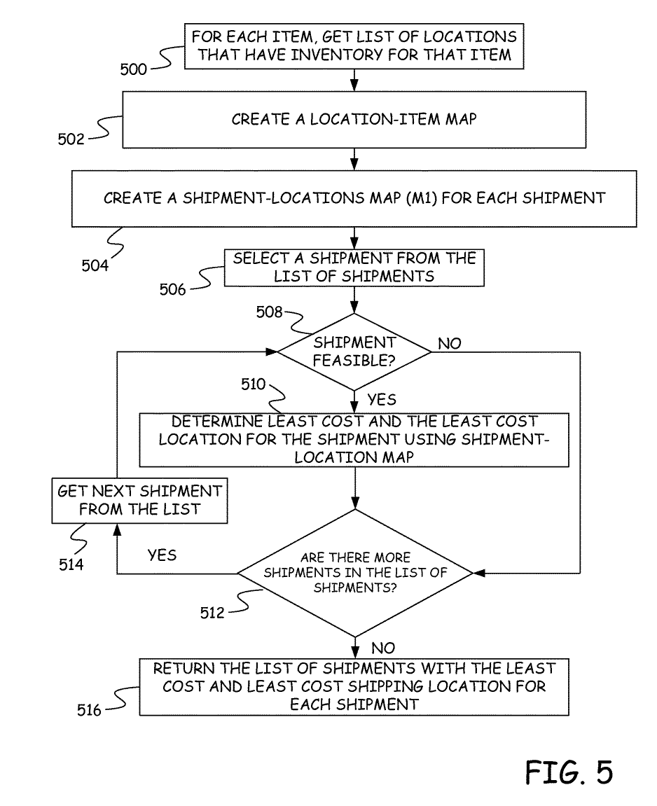

At step 106, a least cost/least cost location identifier 224 produces a shipment list with least cost locations 226. In particular, least cost/least cost location identifier 224 determines which location can ship each shipment in shipment list 222 at the least cost. Thus, each shipment in shipment list 222 has an associated location that can ship the shipment at the lowest cost. The process for determining the least cost shipping location and its associated cost for each shipment is described further below in connection with FIG. 5.

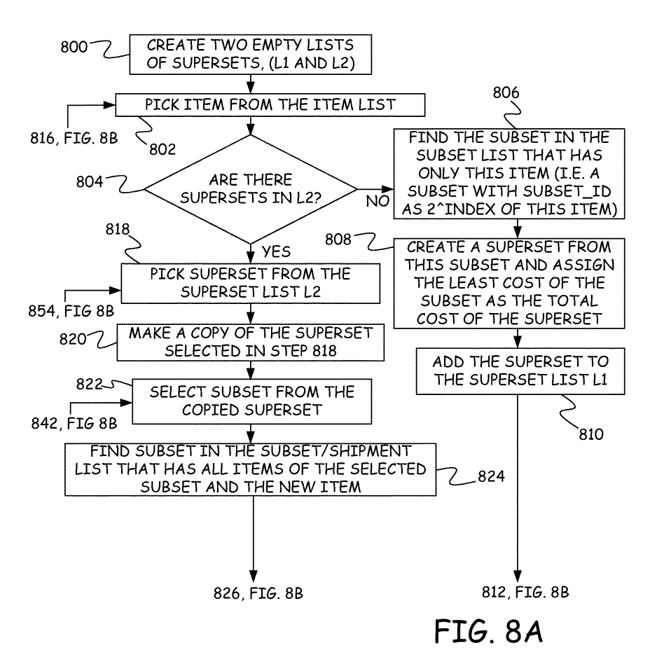

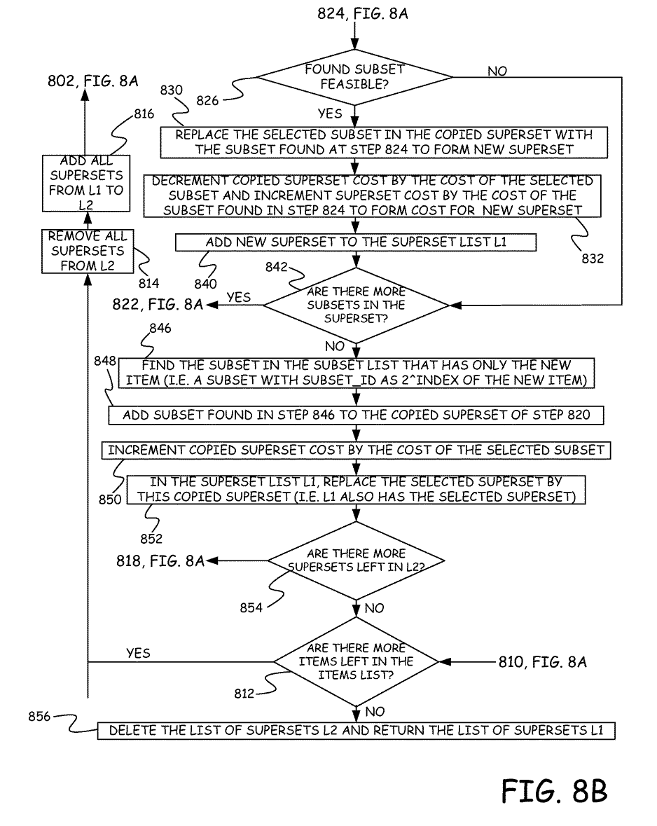

At step 108, a fulfillment identifier 228 generates a list of fulfillment options and fulfillment costs 230 using the shipment list with least cost locations 226. At step 110, a least cost identifier 232 uses fulfillment options and costs 230 to identify a least cost fulfillment option 234. The process of steps 108 and 110 are described further below in connection with FIGS. 8A and 8B. At step 112, a shipping instructor 236 uses least cost fulfillment option 234 to instruct one or more locations, such as locations 238, 240 and 242 to ship items to the ship-to address 218. In accordance with some embodiments, one or more of locations 238, 240 and 242 are physical retail stores having sales floors where customers can shop and purchase items. In these and further embodiments, one or more of locations 238, 240 and 242 are distribution centers that do not have sales floors but instead ship items to consumers and to retail stores. Although only three locations are shown, those skilled in the art will recognize that any number of locations may be used. In particular, shipping instructor 236 instructs each location to send a subset of the items in item list 216 according to the assignment of those items to the locations in least cost fulfillment option 234.

FIGS. 3A and 3B provide a more detailed flow diagram of the process involved in step 104 of FIG. 1, where a list of shipments or subsets is generated from items list 216. In the discussion below, the terms “shipment,” “combination” and “subset” refer to the same thing and are used interchangeably to refer to a combination of one or more items in items list 216.

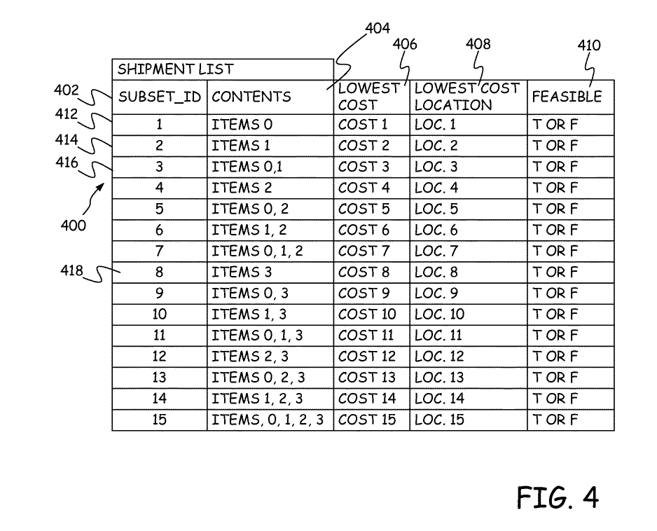

At step 300 of FIG. 3A, an empty shipment list 222 is created and a subset_ID value is initialized at 0. FIG. 4 provides an example of a shipment list 400 for an order containing four items. When completed, shipment lists 222/400 are indexed lists of subsets that have a separate entry for each subset. At step 300, shipment list 400 would not include any entries such as entries 412, 414, 416 and 418. Shipment lists 222/400 include a subset_ID column 402, a contents column 404, cost column 406, a lowest cost location 408 and a feasible column 410. Subset_ID column 402 contains a subset_ID or index number for each subset, contents column 404 contains an identification of the items that are in the subset, cost column 406 includes the lowest cost for shipping all of the items in the subset, lowest cost location 408 includes an identifier for the location that can ship all the items of the subset at the lowest cost and feasible column 410 includes a Boolean value indicating whether the subset is capable of being shipped from at least one location. In FIG. 4, different lowest cost values and different lowest cost locations are shown for each subset. However, those skilled in the art will recognize that one or more subsets may have the same lowest cost or the same lowest cost location.

At step 302, shipment generator 220 selects a next item from item list 216. When step 302 is first performed, the first item in the item list is selected. At step 304, the subset_ID variable is incremented by 1 and a new subset entry is created in shipment list 222. For example, entry 412 of shipment list 400 would be created with subset_ID column 402 set to 1 and the remaining columns left empty.

At step 306, the item selected at step 302 is added to contents column 404 of the entry created at step 304. For example, item 0 in the item list would be added to column 404 of entry 412 the first time step 306 is performed. Note that the items in the item list are indexed beginning with an index number of 0 and ending with a number equal to the total number of items, N, minus 1. Thus, for an order with four items, the items are indexed from 0 to 3.

At step 308, the method determines if there is more than one subset in the shipment list 222/400. If there is only one subset in the shipment list, the process continues at step 310 where it determines if there are more items left in the item list. If there are more items in the item list, the process returns to step 302 and the next item from the item list is selected. Steps 304 and 306 are then performed to add a new entry for the newly selected item such as entry 414 in shipment list 400. At step 308, if there is more than one subset in the shipment list, the process continues at step 312 where a copy of each subset in the shipment list excluding the last added subset is copied. At step 314, the first copied subset is selected and the last item selected at step 302 is added to this copied subset. The subset_ID is then incremented by 1 at step 318 and the incremented subset_ID is assigned to the copied subset. The copied subset is then added as an entry in shipment list 222. An example of such an entry is entry 416 of FIG. 4 in which item 1 has been added to the items in a copy of subset 412.

At step 322, the process determines if there are more subsets in the copied subsets. If there are more subsets, the next copied subset is picked at step 324 and the process returns to step 316. In step 316, the last item selected at step 302 is added to this newly selected copied subset and steps 318 and 320 are repeated. When there are no more subsets in the copied subsets at step 322, the process returns to step 310 to see if there are more items in the item list. If there are more items in the item list, the process returns to step 302 and steps 304-322 are repeated for the next item in item list 216. When there are no more items left in item list 216 at step 310, the list of subsets is returned as shipment list 222.

After shipment list 222 has been created at step 104, least cost/least cost location identifier 224 determines the least cost shipping location for each shipment/subset in shipment list 222. FIG. 5 provides a flow diagram of a method of determining the least cost and least cost shipping location for each shipment/subset. At step 500, for each item in item list 216, least cost location identifier 224 identifies the locations that have the item in inventory. In accordance with some embodiments, least cost location identifier 224 uses a collection of location inventory tables 250 to determine whether a location has a particular item. Location inventory tables 250 include a separate inventory table 252 for each location. Each location inventory table 252 includes an item identifier 254, an item cost 256, an item handling cost 258, and a number of items 260. Item identifier 254 identifies the item and item cost 256 represents the cost of the item at the location. Item handling cost 258 is the cost for preparing the item for shipment from the location and number of items 260 is how many of this item are at the location. Each location inventory table inventory table 252 is produced based on information provided by each of the locations, such as locations 238, 240 and 242 through network 215 and a network interface on server 214. In step 500, least cost location identifier 242 searches every location inventory table 252 for the item identifier of each item in item list 216. For each item, a list of locations that have at least one of the item in inventory is created.

At step 502, a location-item map 262 is formed from the lists of locations that have each item. In particular, for each location that has at least one item in item list 216, a list of all of the items in item list 216 that are found at that location is created at step 502.

At step 504, least cost location identifier 242 creates a shipment-location map 264 that provides a list of locations for each shipment or subset in shipment list 222, where each location in the list of locations has all of the items in the shipment/subset.

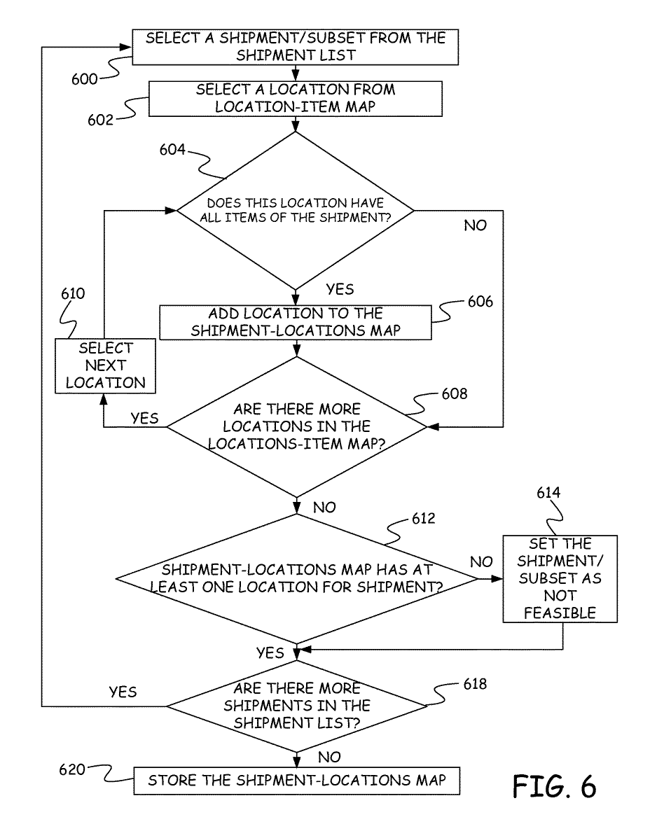

The process of step 504 is shown in the flow diagram of FIG. 6. At step 600, a shipment/subset is selected from shipment list 222. At step 602, a location is selected from location-item map 262. At step 604, least cost location identifier 224 determines if the selected location has all items required by the selected subset. If the location has all of the items for the shipment/subset, the location is added to the shipment-location list for the shipment/subset selected at step 600. If the location does not have all the items of the shipment selected at step 600, or after the location is added to the shipment-location list at step 606, the process determines if there are more locations in the locations-item map at step 608. If there are more locations, the next location is selected at step 610 and steps 604, 606 and 608 are repeated.

When there are no more locations in the locations-item map at step 608, the process continues at step 612 where shipment-location map 264 is examined to determine if at least one location has been added for the shipment/subset selected at step 600. If no location has been added for the shipment/subset, the process continues at step 614 where shipment list 222 is updated to set feasible column 410 to false for the shipment/subset. By setting feasible column 410 to false, least cost location identifier 224 indicates that this subset cannot be used in a final shipping plan since it is not feasible to ship this subset from any of the locations. After step 614 or if shipment-locations map 264 includes at least one location for the current shipment/subset at step 612, the process continues at step 618 where it determines if there are more shipments/subsets in shipment list 222. If there are more shipments/subsets, the process returns to step 600 and a new shipment/subset is selected from shipment list 222. Steps 602-614 are then repeated for the newly selected shipment/subset. When all of the shipments/subsets have been processed at step 618, the method continues at step 620 where the shipment-location map 264 is stored.

Returning to FIG. 5, after shipment-location map 264 is created at step 504, a shipment/subset is selected from shipment list 222 at step 506. At step 508, the entry for the selected shipment in shipment list 222 is examined to determine if the shipment is feasible. If the shipment is not feasible, the process moves on to step 512 where it determines if there are more shipments/subsets in shipment list 222. If there are more shipments, the next shipment is selected from shipment list 222 at step 514 and that shipment is examined to see if it is feasible at step 508.

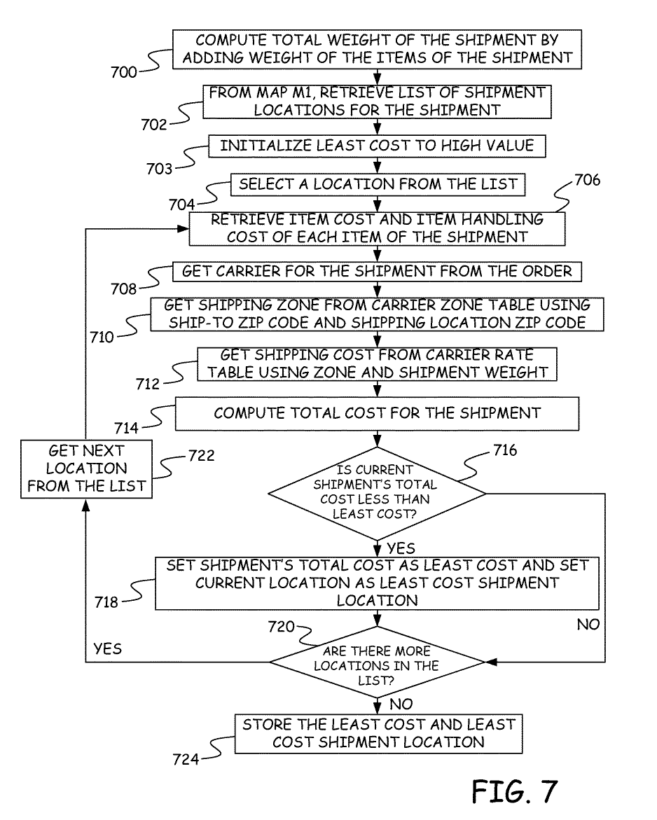

If a shipment is feasible, the least cost and the least cost location for that shipment is determined at step 510 using the shipment-locations map 264. FIG. 7 provides a flow diagram of a method of performing step 510.

In step 700 of FIG. 7, the total weight of the shipment/subset selected at step 506 is computed by adding together the weights of the items of the shipment/subset. These weights can be retrieved from an item weight table 266 (FIG. 2) that contains an item identifier 268 and a corresponding weight 270 for each item. At step 702, a list of shipment locations for the shipment selected at step 506 of FIG. 5 is retrieved from shipment-locations map 264. At step 703, a least cost variable is set to an initial high value. This high value is selected to be higher than any anticipated cost for shipping the subset of items.

At step 704, a location is selected from the locations listed in shipment-locations map 264 for this shipment/subset. At step 706, an item cost and an item handling cost are retrieved for each item in the shipment/subset based on the location selected at step 704. In particular, the inventory table 252 for the location is selected from inventory tables 250 and the item cost 256 and handling cost 258 for each item 254 in the shipment is retrieved from that table. At step 708, a carrier identifier 212 from order 206 is retrieved and at step 710, the carrier 212 is used to identify a shipping zone using a carrier zone table 272. Carrier zone table 272 is part of a collection of carrier zone tables 274 with one carrier zone table for each possible carrier. Each carrier zone table 272 includes a ship-from zip code field 276, a ship-to zip code filed 278 and a carrier zone 280. Ship-from zip code 276 represents the location that will be shipping the subset, ship-to zip code 278 represents the zip code in ship-to address 218 and carrier zone 280, represents a collection of shipping rates for various weights of items.

At step 712, a shipping cost is retrieved from a carrier rate table 282, which is one of a plurality of carrier rate tables 284. Carrier rate table 282 includes a shipping zone 286, a weight 288 and a shipping cost 290. For each combination of a shipping zone and a weight, carrier rate table 282 provides a corresponding shipping cost 290. Thus, using the weight determined at step 700 and the shipping zone determined at step 710, the rate 290 can be retrieved at step 712 using carrier table 282.

At step 714, a total cost for the shipment/subset for the location selected at step 704 is computed. This cost is referred to as a subset fulfillment cost. In some embodiments, this cost includes just the shipping cost determined at step 712. In other embodiments, this cost is the sum of the handling cost of each item retrieved at step 706 added to the shipping cost determined at step 712. In still further embodiments, this cost is the sum of the item cost of each item in the shipment plus the sum of the handling cost of each item in the shipment plus the shipping cost determined at step 712. The sum of the handling costs for the items in the shipment represents a handling cost for preparing the shipment for shipping from the location.

At step 716, the current shipment's total cost is compared to the current value of the least cost variable. If the current shipment's total cost is not less than the value of the least cost variable, the process continues at step 720 where it determines if there are more locations for this shipment/subset in shipment-locations map 264. If there are more locations, the next location is retrieved from map 264 at step 722 and steps 706-718 are repeated for the new location. If the current shipment's total cost is less than the least cost variable at step 716, the shipment's total cost for the currently selected location is set as the value for the least cost variable and the current location is set as the least cost location for the shipment selected at step 506 or step 514 of FIG. 5.

When there are no more locations in the shipment-location map 264 for the current shipment/subset, the process ends at step 724 and the least cost for this shipment and the least cost shipment location for this shipment are stored in shipment list with least cost locations 226.

Returning to FIG. 5, when the least cost and the least cost location for the current shipment has been determined at step 510, the process continues at step 512 where it determines if there are more shipments in shipment list 222. If there are more shipments/subsets, the next shipment/subset is selected at step 514 and steps 508, 510 and 512 are repeated for the next shipment/subset. When there are no more shipments/subsets in shipment list 222, the process of FIG. 5 ends at step 516 where shipment list with least cost locations 226 is returned. In shipment list 226, cost field 404 and lowest cost location field 408 (FIG. 4) of each feasible shipment have associated values.

Returning to FIG. 1, after the least cost and the least cost shipping location have been determined for each feasible shipment/subset in shipment list 226, a list of fulfillment options and fulfillment costs are determined from the shipment list 226 at step 108. FIGS. 8A and 8B provide a method for generating the list of fulfillment options and fulfillment costs and for selecting the least cost fulfillment option as found in steps 108 and 110.

In FIGS. 8A and 8B, a fulfillment option is referred to as a superset, which is a collection of subsets that contains every item in the order.

At step 800 of FIG. 8A, two empty lists, L1 and L2, of supersets are created. At step 802, an item is selected from item list 216 by fulfillment identifier 228. At step 804, superset list L2 is examined to determine if there are any supersets in L2. Since initially there are no supersets in list L2, the process continues at step 806 where shipment list 222 is accessed to find a subset that only has the item selected at step 802. This subset will have a subset_ID that is equal to 2 raised to the power of the index of the item selected at step 802, where the items are indexed in the list from 0 to the number of items, N, minus 1. For example, if the fourth item in the item list had been selected at step 802, its index number would be 3 and the subset_ID for the subset that only contains the fourth item 2³ or 8. Thus, the subset that contains only the item with index number 3 is found at subset_ID 8 as is shown by entry 418 of FIG. 4.

After the subset that contains only the item selected at step 802 has been found at step 806, a superset is created from this subset. The total cost for this superset is assigned the least cost 406 of the subset found at step 806. This superset is then added to superset list L1 at step 810 along with the cost for the superset. The process then continues at step 812 where it determines if there are any more items left in the item list. If there are more items left in the item list, any supersets that are currently in lists L1 and L2 are partial supersets. All of the partial supersets are removed from L2 at step 814 and all of the partial supersets from superset list L1 are moved to the superset list L2 at step 816. The process then returns to step 802 of FIG. 8A to select a next item from item list 216.

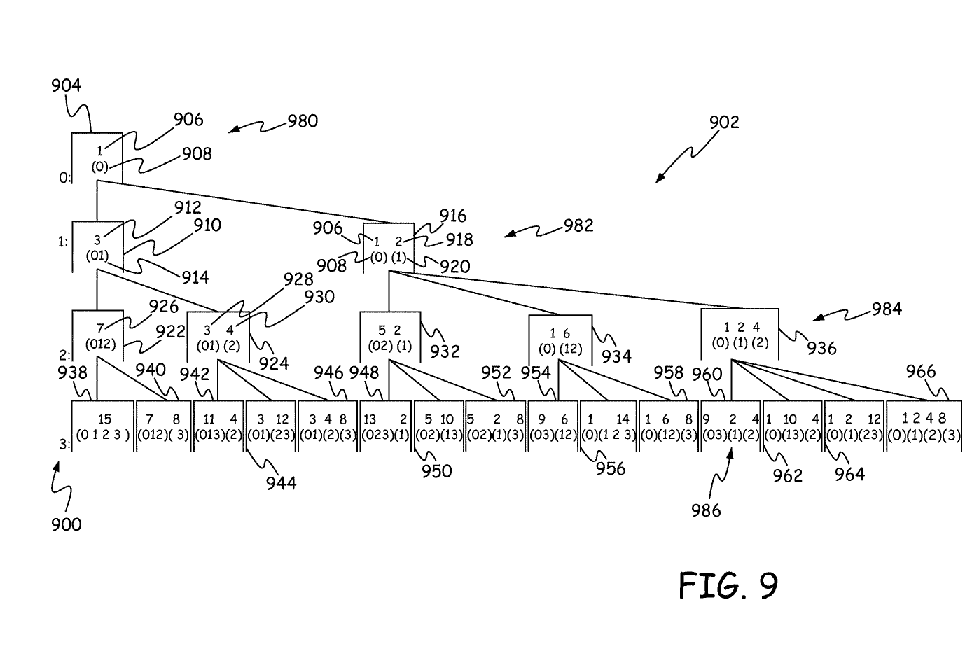

FIG. 9 shows the contents of superset list L1 at step 812. In FIG. 9, a separate row such as rows 980, 982, 984, and 986, is provided for each time step 812 is reached when processing a 4-item list. Thus, row 980 shows the contents of L1 the first time step 812 is reached, row 982 shows the contents of L1 the second time step 812 is reached and so forth. In FIG. 9, column 900 contains the index of the item last added to list L1 with the first item having an index of zero and the last item having an index of N−1 where N is the number of items. FIG. 9 also includes a structure 902 showing how a superset created for a previous item is expanded for a next item to create additional supersets in list L1. After first item 0 has been processed in FIGS. 8A and 8B, a single superset 904 has been created that contains a single subset_ID 906, that has item contents 908. In particular, subset_ID 906 is “1” and contains only item 0.

Returning to step 802, a next item, item 1 in FIG. 9, is selected. At step 804, there are supersets in L2 since superset 904 of FIG. 9 has been copied to L2 at step 816. At step 818, this superset is selected and a copy of the superset is made at step 820. At step 822, a subset is selected from the copied superset. For item 1, this involves selecting subset 906 of FIG. 9. At step 824, a search is performed to find a larger subset in shipment list 222 that has all of the items in the selected subset plus the new item selected at step 802. For example, after the second item with item index “1” is selected at step 802, step 824 involves finding a subset in shipment list 222 that includes item 908 of subset 906 of FIG. 9 as well as the second item with index “1”.

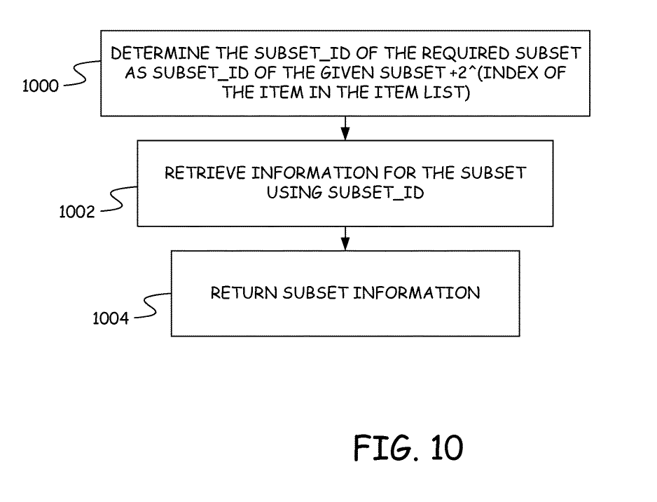

FIG. 10 provides a flow diagram of a method of performing step 824 of FIG. 8. Instead of performing a search that involves examining the contents of each subset of shipment list 222 in order to find a subset that includes all the items of a selected subset and a new item, the method of FIG. 10 relies on the structure of shipment list 222 to perform a search based on the index of the item and the subset_ID of the selected subset. In particular, at step 1000, the subset_ID of the desired subset is identified as the subset_ID selected at step 822 plus 2 raised to the power of the index of the item selected at step 802. For example, when the subset selected at step 822 is subset 906, which has a subset_ID of 1, and the next item from the item list selected at step 802 has an index value of 1, the desired subset_ID is found by taking 1 (the subset_ID of subset 906) and adding 2 raised to the power of 1 (the index number of the item selected at step 802), or 1+2¹=3. As indicated by entry 416 of FIG. 4, subset_ID 3 corresponds to a subset containing items 0 and 1, which is the combination of the items in subset_ID 1 and item 1. At step 1002, all of the information for the desired subset is retrieved including the contents of the subset, the least cost for the subset, the least cost location for the subset and the feasibility of the subset. At step 1004, this information is returned.

Returning to FIG. 8B, after the subset has been found that has all of the items of the selected subset and the new item, the found subset is examined to determine if it is feasible at step 826. If it is not feasible, the process continues at step 842. If the found subset is feasible at step 826, the subset selected at step 822 is replaced in the copied superset with the subset found in step 824 to form a new superset. At step 832, a superset cost for the superset copied at step 820 is decremented by the cost of the subset selected at step 822 and is incremented by the least cost of the subset found in step 824. At step 840, the copied superset and its costs are added to the superset list L1. This is shown in FIG. 9 with the addition of superset 910 that includes subset 912 having an subset_ID of 3 and containing items 914 consisting of items 0 and 1.

After the copied superset has been added to superset list L1, the process determines if there are more subsets in the superset selected at step 818. If there are no more subsets, as would be the case when processing the second input item having an index value of 1, the process continues at step 846, where a subset is found in shipment list 222 that has only the item selected at step 802. This subset can be found by looking for a subset with a subset_ID that is equal to 2 raised to the power of the index of the item selected at step 802. For example, for the second item having an index of 1, the subset_ID would be 2 raised to the power of 1. As shown in FIG. 4, entry 412 is for this subset_ID and contains only item 1.

At step 848 the subset found in step 846 is added to the superset copy formed in step 820. In FIG. 9, this produces superset 916, which includes subset 906 and subset 918. Subset 906 has a subset_ID of 1 and subset 918 has a subset_ID of 2. At step 850, the superset cost of the superset copy is incremented by the least cost of the subset found in step 846. For example, in FIG. 9, the cost of superset 904 would be incremented by the cost of subset 2. In step 852, the superset in L1 corresponding to the superset selected at step 818 is replaced with the copy of the superset formed through steps 848 and 850. Thus, in FIG. 9, superset 904 is replaced with superset 916 which includes subset 906 and subset 918. Subset 906 includes item 908 with an item index of 0 and subset 918 includes item 920 with an item index of 1.

At step 854, the process determines if there are more supersets left in L2. If there are no more supersets left in list L2, the process continues at step 812 where the next item is selected. The process then continues at step 814 where all of the supersets are removed from L2. After the supersets are removed from L2 the supersets from list L1 are added to list L2 at step 816. The process then selects the next item from the item list at step 802.

If there are more supersets left in list L2 at step 854, the process returns to step 818 where the next superset from list L2 is selected.

Steps 804, 818, 820, 822, 824, 826, 830, 832, 840, 842, 846, 848, 850, 852, 854 and 812 are repeated for the newly selected item and for each remaining item in the item list.

FIG. 9 shows the formation of the supersets by repeating these steps. For example, when the third item, having item index 2 is selected, steps 820-852 are performed for superset 910 resulting in supersets 922 and 924 with superset 922 consisting of subset 926, and superset 924 consisting of subsets 928 and 930. When steps 820-852 are performed for superset 916, supersets 932, 934 and 936 are produced.

Additionally, when steps 820-852 are performed for superset 922, supersets 938 and 940 are produced; when steps 820-852 are performed for superset 924, supersets 942, 944 and 946 are produced; when steps 820-852 are performed for superset 932, supersets 948, 950 and 952 are produced; when steps 820-852 are performed for superset 934, supersets 954, 956 and 958 are produced and when steps 820-852 are performed for superset 936, supersets 960, 962, 964 and 966 are produced.

Each of supersets 938-966 contain all of the items of the item list and each have an associated lowest total cost which is the sum of the least cost of each subset that makes up the superset.

Although FIG. 9 is shown for an example with four items, those skilled in the art will recognize that the method may be implemented on any number of items in an item list.

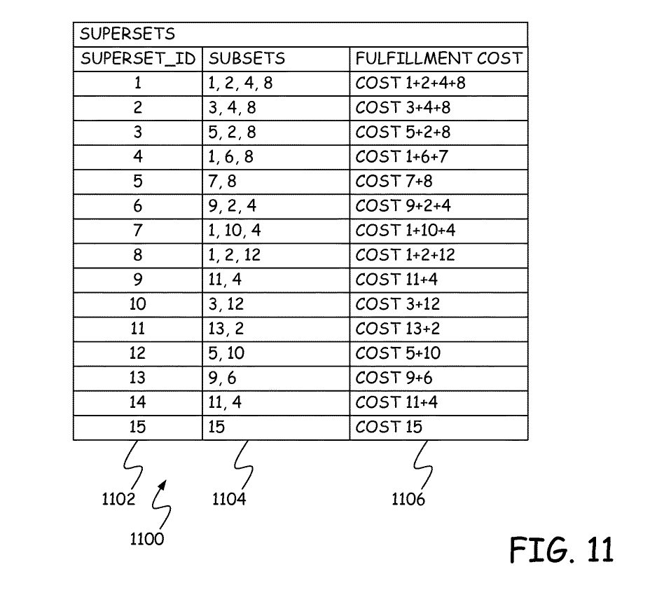

At step 856, any supersets remaining in list L2 are deleted and the list of supersets in list L1 are returned by fulfillment identifier 228 as fulfillment options and costs 230. FIG. 11 provides an example 1100 of fulfillment options and costs 230. In example 1100, each superset has three fields: superset_ID field 1102, subsets field 1104 and fulfillment cost field 1106. Superset_ID field 1002 provides an identifier for the superset, subsets field 1104 provides a list of the subsets in the superset, and fulfillment cost field 1106 contains the total fulfillment cost for the superset. The total fulfillment cost of field 1106 is the sum of the least cost of each subset in the superset.

At step 110 of FIG. 1, least cost identifier 232 examines total fulfillment cost field 1106 for each fulfillment option in fulfillment options 230 and selects the fulfillment option with the lowest total fulfillment cost. Each subset of the selected superset is then shipped from its least cost location at step 112. In many instances, this results in items being shipped from different locations in order to fulfill the order.

The methods described above improve the functioning of the computer by reducing the length of time it takes the computer to find the least cost option for fulfilling an order. For example, for a 3-item order, identifying the least cost fulfillment option when one hundred locations can provide each item would require on the order of one million operations. However, using the embodiment described above, the same least cost fulfillment option can be found using on the order of one thousand operations.

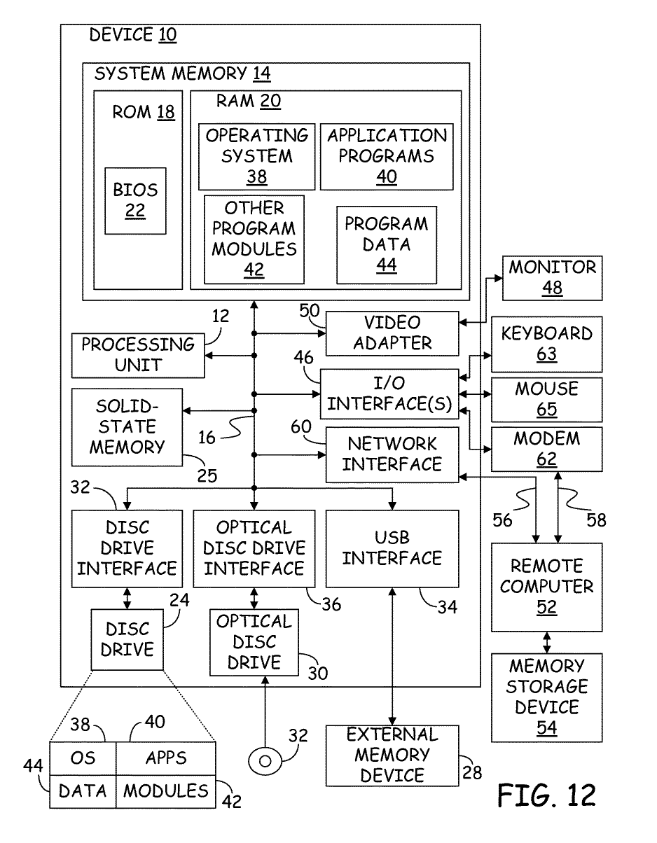

FIG. 12 provides an example of a computing device 10 that can be used as a server device in the embodiments above. Computing device 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes a hard disc drive 24, an external memory device 28, and an optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing server 214 including programs for implementing shipments generator 220, least cost/least cost location identifier 224, fulfillment identifier 228, least cost identifier 232 and shipping instructor 236, for example. Program data 44 may include data such as product inventories for a plurality of locations, which in some embodiments take the form of location inventory tables 250. Program data 44 can also include carrier zone tables 274, carrier rate tables 284, item weight table 266, shipment list 222, items list 216, ship-to address 218, location-item map 262, shipment-locations map 264, shipment list with least cost locations 226, fulfillment options and costs 230 and least cost fulfillment option 234.

Processing unit 12, also referred to as a processor, executes programs in system memory 14 and solid state memory 25 to perform the methods described above.

Input devices including a keyboard 63 and a mouse 65 are connected to system bus 16 through an Input/Output interface 46 that is coupled to system bus 16. Monitor 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 12. The network connections depicted in FIG. 12 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46. Order 206 is received through either network interface 60 or modem 62.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 12 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A computer-implemented method for improving the functioning of a computer, the method comprising:
receiving a list of items in a purchase order;
accessing inventories of items available at each of a plurality of locations;
improving the functioning of the computer by reducing the number of combinations of locations and items that must be considered to find a combination of locations and items that provides a lowest total fulfillment cost through steps comprising:
identifying all combinations of the items in the list of items;
for each combination, identifying from the inventories which location can ship that combination at a lowest fulfillment cost for the combination;
identifying all fulfillment supersets that can be formed from the combinations, where each fulfillment superset provides all of the items in the list of items and has a total fulfillment cost that is the sum of the lowest fulfillment costs for the combinations used to form the fulfillment superset; and
selecting one fulfillment superset from all fulfillment supersets so that the selected fulfillment superset has the lowest total fulfillment cost among all of the fulfillment supersets.

2. The computer-implemented method of 1 wherein identifying from the inventories which location can ship a combination at a lowest fulfillment cost comprises:
identifying all locations that can ship the combination;
determining a fulfillment cost for each location that can ship the combination; and
selecting the location with the lowest fulfillment cost for the combination.

3. The computer-implemented method of claim 2 wherein determining a fulfillment cost for a location that can ship a combination comprises:
identifying an item handling cost for preparing the combination for shipping from the location;
determining a shipping cost for shipping the combination from the location to a destination; and
combining at least the item handling cost with the shipping cost to form the fulfillment cost.

4. The computer-implemented method of claim 3 wherein determining a shipping cost for shipping the combination comprises:
determining a weight for the combination;
determining a shipping zone for shipping from the location to the destination; and
using a carrier identifier in the order to determine the shipping cost based on the weight and the shipping zone.

5. The computer-implemented method of claim 3 wherein determining a fulfillment cost for a location that can ship a combination further comprises:
determining a cost of the item at the location; and
combining the item cost with the item handling cost and the shipping cost to form the fulfillment cost.

6. The computer-implemented method of claim 1 wherein the plurality of locations comprise at least one physical retail store comprising a sales floor.

7. The computer-implemented method of claim 1 wherein the plurality of locations comprise at least one distribution center that distributes merchandise to physical retail stores.

8. A method of shipping retail items, the method comprising:
receiving a list of items to be shipped to a same destination;
for each subset of one or more items in the list of items, identifying whether there is one shipping location from a plurality of shipping locations that can ship the subset of items at a lowest cost;
forming a superset of locations, wherein each location in the superset can ship at least one subset of items at a lowest cost, and wherein the superset of locations provides a lowest cost to package and ship all of the items of the list of items to the same destination; and
shipping the items from the locations in the superset to the same destination.

9. The method of claim 8 wherein identifying whether there is one shipping location that can ship the subset of items at a lowest cost comprises determining that none of the shipping locations can ship the subset of items and marking the subset as not being feasible.

10. The method of claim 8 wherein identifying whether there is one shipping location that can ship the subset of items at a lowest cost comprises:
for each subset, identifying all locations that can ship the subset;
determining a cost for the subset for each location; and
selecting the location with the lowest cost.

11. The method of claim 10 wherein determining a cost for a subset for a location comprises:
determining a handling cost for preparing the subset of items for shipping from the location;
determining a shipping cost for delivering the subset of items from the location to the same destination; and
summing at least the handling cost and the shipping cost to determine the cost for the subset for the location.

12. The method of claim 8 wherein forming a superset of locations comprises forming a plurality of supersets of locations, each superset of locations in the plurality comprising a combination of locations that can ship all of the items of the list of items.

13. The method of claim 12 wherein forming a plurality of supersets of locations comprises determining a cost to package and ship all of the items for each superset of locations, wherein determining a cost to package and ship all of the items for a superset of locations comprises summing a lowest cost for each location in the superset of locations.

14. The method of claim 8 wherein the plurality of shipping locations comprise physical retail stores.

15. A server comprising:
a memory that stores product inventories for a plurality of locations;
a network interface that receives a list of items to be shipped to a destination; and
a processor that determines which locations will ship which items in the list of items through a process comprising:
identifying all possible subsets of items in the list of items;
identifying a lowest cost location for each subset of items; and
combining lowest cost locations to form a superset of locations such that, together, the locations of the superset of locations will ship all of the items in the list of items.

16. The server of claim 15 wherein identifying a lowest cost location for a subset of items comprises:
determining which locations can ship all of the items of the subset;
for each location that can ship all of the items of the subset, determining a subset fulfillment cost for at least handling and shipping all of the items of the subset from the location; and
selecting the location with the lowest subset fulfillment cost as the lowest cost location for the subset of items.

17. The server of claim 15 wherein identifying all possible subsets of items in the list of items and identifying a lowest cost location for each subset of items comprises generating an indexed list of subsets of items, the indexed list of subsets of items comprising a separate entry for each subset of items, each entry comprising an index number, an identification of the items in the subset, a lowest cost for the subset of items, and the lowest cost location for the subset of items.

18. The server of claim 17 wherein combining lowest cost locations to form a superset of locations comprises:
constructing a partial superset comprising at least one subset, the partial superset lacking at least one item;
selecting at least one item lacking from the partial superset;
determining an item number for the selected item;
selecting a subset in the partial superset;
using an index of the selected subset in the partial superset and the item number to identify an index of a larger subset that includes all of the items of the selected subset and the selected item; and
forming a new superset by replacing the selected subset in the partial superset with the larger subset.

19. The server of claim 18 wherein combining lowest cost locations to form a superset of locations further comprises:
for each subset in the partial superset, performing the steps of:
selecting the subset in the partial superset;
using an index of the selected subset in the partial superset and the item number to identify an index of a larger subset that includes all of the items of the selected subset and the selected item; and
forming a new superset by replacing the selected subset in the partial superset with the larger subset.

20. The server of claim 15 wherein combining lowest cost locations to form a superset of locations such that, together, the locations of the superset of locations will ship all of the items in the list of items comprises forming a plurality of supersets of locations and selecting one of the plurality of supersets of locations based on costs associated with the supersets of locations.
